(19) United States
(12) Patent Application Publication
(10) Pub. No.: US 2014/0368577 A1
(43) Pub. Date: Dec. 18, 2014

(54) INKJET RECORDING APPARATUS AND CONTROL METHOD FOR WIPING UNIT

(71) Applicant: CANON KABUSHIKI KAISHA, Tokyo (JP)

(72) Inventors: Tsuyoshi Ibe, Yokohama-shi (JP); Masaya Uetsuki, Yokohama-shi (JP); Toshimitsu Danzuka, Tokyo (JP); Masataka Kato, Yokohama-shi (JP); Asako Tomida, Kawasaki-shi (JP); Hiroaki Komatsu, Yokohama-shi (JP)

(21) Appl. No.: 14/301,802

(22) Filed: Jun. 11, 2014

(30) Foreign Application Priority Data
Jun. 14, 2013 (JP) 2013-125713

(51) Int. Cl. B41J 2/165

(52) U.S. Cl. CPC B41J 2/16535
USPC 347/33

(57) ABSTRACT

While a wiping operation for keeping a satisfactory ejection opening surface of an inkjet recording head is performed, a usage amount of a sheet-like member is to be reduced. A contamination state of a wiping area after the wiping operation is determined, and a timing of reeling the sheet-like member in a wiping unit is controlled in accordance with a determination result of the contamination state.

### BACKGROUND OF THE INVENTION

1. Field of the Invention

The present invention relates to an inkjet recording apparatus and a control method for a wiping unit.

2. Description of the Related Art

When ink is ejected from an ejection opening of a recording head of an inkjet recording apparatus, ink mist that is not landed on a recording medium is generated. The ink mist is deposited on an ejection opening surface of the recording head or the like and may prevent the ink ejected from the ejection opening from landing at a normal position. The ink mist deposited on the ejection opening surface is normally removed by a wiper blade.

In recent years, a technology for solidifying the ink on the recording medium by using ultraviolet rays, micro waves, heat, or the like has been developed to perform recording on the recording medium that does not have an ink receptor layer. In the above-described configuration, thermal fixing ink or the like which is easily be solidified on the recording medium by the heat or the like is used. According to such configuration, the ink mist deposited on the ejection opening surface is also solidified on the ejection opening surface and may prevent the ink from the ejection opening from landing at a normal position. Since the ink mist according to the above-described inkjet recording technology is firmly solidified, it is difficult to remove the ink mist by a normal wiper blade in some cases.

U.S. Pat. No. 6,692,100 discloses a recording apparatus in which a sheet-like member is supplied to a position facing the ejection opening surface, and this sheet-like member is abutted against the ejection opening surface to perform wiping, so that the ejection opening surface is cleaned. U.S. Pat. No. 6,692,100 also discloses that the sheet-like member that has once been used for the wiping is reeled by a reeling roller, so that an unused part of the sheet-like member is supplied to the position facing the ejection opening surface.

Incidentally, since the sheet-like member is reeled for every wiping operation in the recording apparatus according to U.S. Pat. No. 6,692,100, even a site of sheet-like member where the contamination is moderate and the ejection opening surface can be cleaned again may be reeled in some cases. To elaborate, the sheet-like member is not reeled at an appropriate timing in accordance with a degree of contamination of the sheet-like member in the recording apparatus according to U.S. Pat. No. 6,692,100, and much of the sheet-like member may be consumed beyond necessity.

On the other hand, it is also conceivable to perform the reeling operation for every certain number of the wiping operations, but in such case, much of the contamination caused by the wiping operation is accumulated at a predetermined site of the sheet-like member. For this reason, even when the wiping operation is performed at this predetermined site, the ink solidified on the ejection opening surface may not sufficiently be removed.

### SUMMARY OF THE INVENTION

According to an aspect of the present invention, there is provided an inkjet recording apparatus that can reduce a usage amount of the sheet-like member by performing a control to reel the sheet-like member at an appropriate timing while the wiping operation for keeping the satisfactory ejection opening surface is performed.

According to another aspect of the present invention, there is provided an inkjet recording apparatus including: an inkjet recording head including an ejection opening surface from which ink is ejected; a wiping unit configured to wipe the ejection opening surface; a changing unit configured to perform a changing operation for changing a wiping area of the wiping unit; a determination unit configured to determine a contamination state of the wiping area; and a control unit configured to cause the changing unit to perform the changing operation on the basis of a determination result of the determination unit.

Further features of the present invention will become apparent from the following description of exemplary embodiments with reference to the attached drawings.

### BRIEF DESCRIPTION OF THE DRAWINGS

FIG. 1 is a schematic diagram of an inkjet recording apparatus according to exemplary embodiments of the present invention.

FIG. 2 is a schematic diagram of a recording head.

FIG. 3 is a schematic diagram of an internal mechanism of the inkjet recording apparatus.

FIGS. 4A to 4D are schematic diagrams of the wiping operation.

FIG. 5 is a block diagram of a control circuit.

FIG. 6 is a flow chart of a wiping operation according to a first exemplary embodiment.

FIG. 7 is a schematic diagram of an internal mechanism of the inkjet recording apparatus according to a second exemplary embodiment.

FIGS. 8A to 8D are schematic diagrams of the wiping operation according to the second exemplary embodiment.

FIG. 9 illustrates a state in which a wiping area of a sheet-like member is divided according to the second exemplary embodiment.

FIG. 10 is a flow chart of the wiping operation according to the second exemplary embodiment.

### DESCRIPTION OF THE EMBODIMENTS

Hereinafter, exemplary embodiments of the present invention will be described with reference to the drawings.

### First Exemplary Embodiment

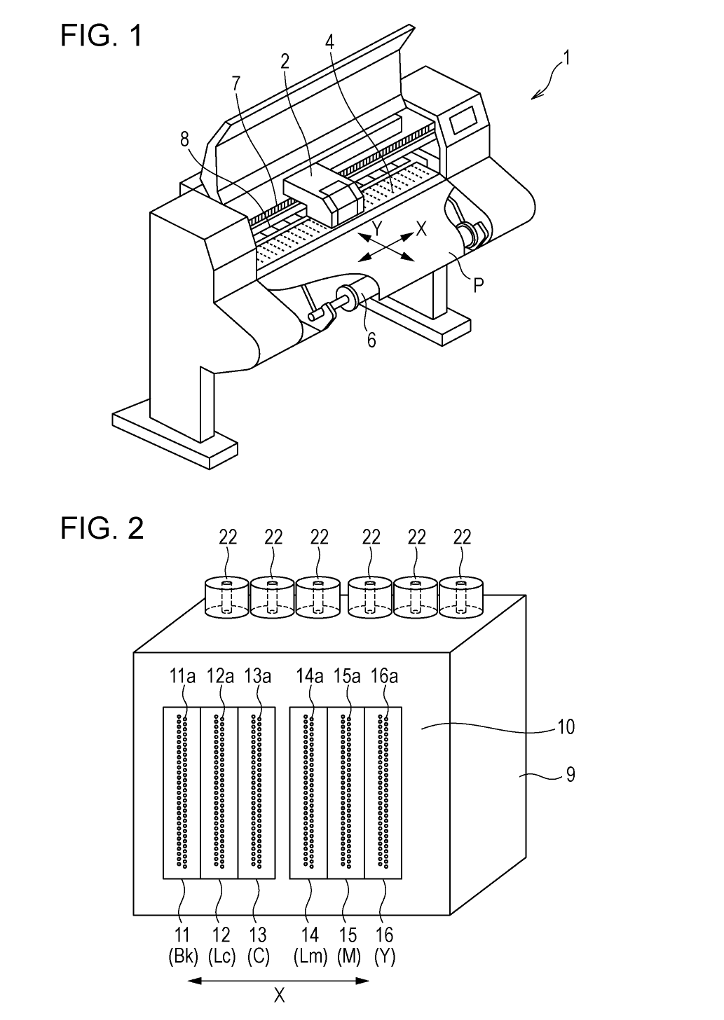

FIG. 1 is a schematic diagram of an inkjet recording apparatus 1 according to the present exemplary embodiment. The inkjet recording apparatus 1 includes a carriage 2 to which a recording head 9 which will be described below is mounted. The recording head 9 is an inkjet recording head. A recording operation is performed by moving the carriage 2 in a main scanning direction X. The main scanning direction X is a direction intersecting with a conveyance direction Y a recording medium P.

The recording medium P is held at a spool 6. The recording medium P held in the spool 6 is conveyed towards a platen 4 by a feed roller which is not illustrated in the drawing. The feed roller is driven by a feed motor 5 which will be described below. The recording medium P is conveyed along the conveyance direction Y on the platen 4.

When the recording medium P is conveyed to a recording position facing the recording head 9 mounted to the carriage 2, the carriage 2 is moved in the main scanning direction X along a guide shaft 8. During this movement, ink is ejected from the recording head 9. A timing at which the ink is ejected is determined on the basis of a position signal obtained by an encoder 7.

After the recording operation at the recording position is ended, the recording medium P is conveyed at a predetermined amount along the conveyance direction Y, and a new area of the recording medium P faces the recording head 9. The next recording operation is also performed on this new area of the recording medium P by the recording head 9.

FIG. 2 is a schematic diagram of the recording head 9. Ejection opening columns 11 to 16 from which ink of different color tones is ejected are provided on an ejection opening surface 10 of the recording head 9. This ink color tone also includes different colors and different densities. The ejection opening columns 11 to 16 are provided along the main scanning direction X.

The ejection opening columns 11 to 16 are respectively constituted by a plurality of ejection openings 11a to 16a. A plurality of pieces of the ejection openings 11a to 16a constituting the respective ejection opening columns 11 to 16 are respectively arranged in the conveyance direction Y. Ink colors of the ejection opening columns 11 to 16 are respectively black (Bk), light cyan (Lc), cyan (C), light magenta (Lm), magenta (M), and yellow (Y). The ink colors of the ejection opening columns 11 to 16 may also be colors other than those black (Bk), light cyan (Lc), cyan (C), light magenta (Lm), magenta (M), and yellow (Y). The ejection openings 11a to 16a eject ink of a color allocated to each ejection opening among the ink of the plurality of colors. The ejection openings 11a to 16a can eject two or more types of ink. The ejection openings 11a to 16a eject the ink by heat generated by a heater. The ink may be fixed on the recording medium P by the heat.

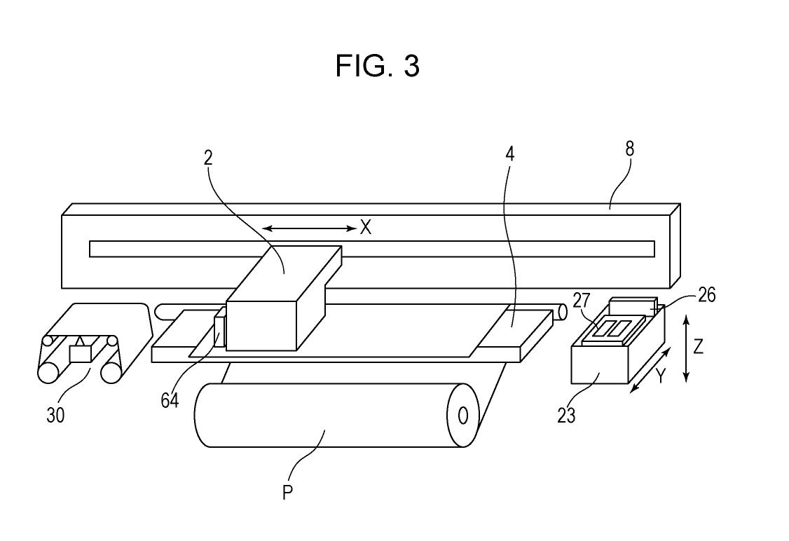

FIG. 3 is a schematic diagram of an internal mechanism of the inkjet recording apparatus 1. A home position and a back position are respectively set on an extension line of both ends of the platen 4 arranged along the main scanning direction X. According to the present exemplary embodiment, a recovery unit 23 is arranged on the home position side, and a wiping unit 30 is arranged on the back position side. The carriage 2 stops at the home position or the back position as appropriate during the recording operation or between the recording operations.

The recovery unit 23 includes a wiper 26, a cap 27, and the like. The wiper 26 wipes the ejection opening surface 10. The cap 27 is elevated and lowered by an elevating and lowering mechanism which is not illustrated in the drawing. The ejection opening surface 10 is capped by elevating the cap 27.

When the carriage 2 is moved on the extension line extending from the platen 4 along the main scanning direction X, the wiping unit 30 wipes the ejection opening surface 10 of the recording head 9. The wiping unit 30 performs the wiping operation in a direction intersecting with the ejection opening columns 11 to 16 (a direction intersecting with the array direction of the ejection openings 11a to 16a, an array direction of the ejection opening columns 11 to 16).

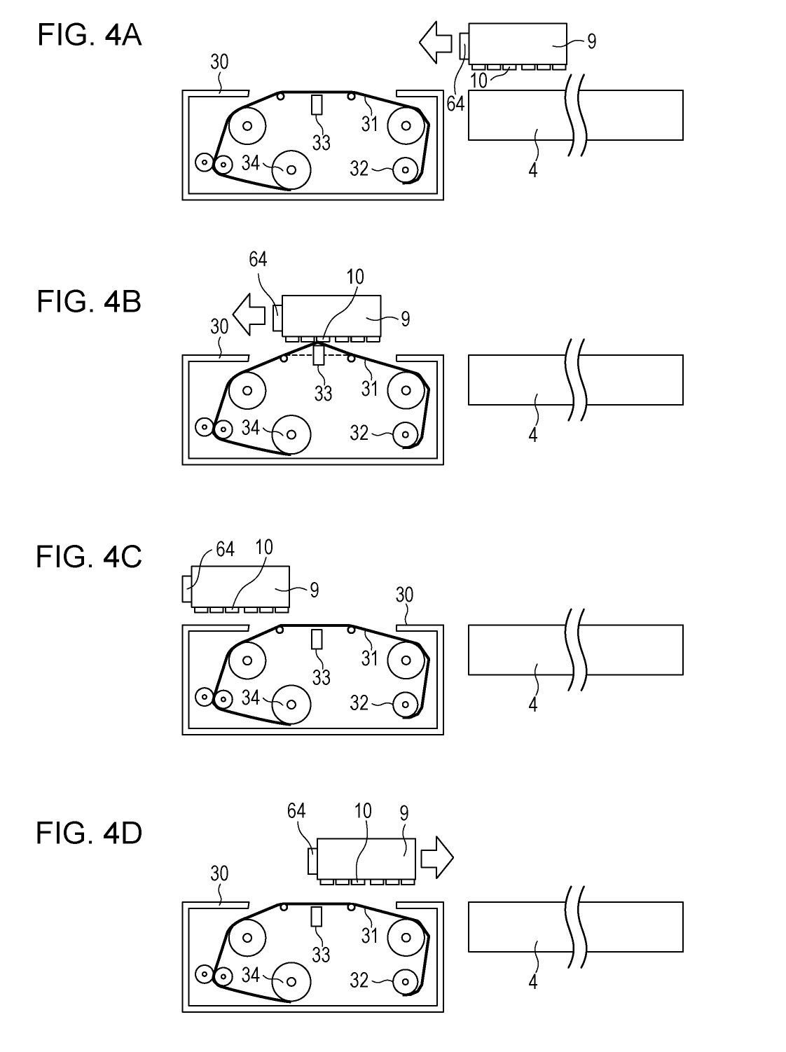

FIG. 4A is a schematic diagram of the wiping unit 30. The wiping unit 30 includes a sheet-like member 31, a reeling roller 32, an abutting member 33, and a feed roller 34. The sheet-like member 31 is a non-woven fabric or the like using porous urethane foam, melamine foam, polyolefin, or PET, nylon, or the like. The sheet-like member 31 is impregnated with wiping solution including water, surfactant, solvent, or the like.

The sheet-like member 31 is pressed up by the abutting member 33, so that the sheet-like member 31 abuts against the ejection opening surface 10. Next, the ejection opening surface 10 and the wiping unit 30 are relatively moved in a state in which the sheet-like member 31 abuts against the ejection opening surface 10, so that the ejection opening surface 10 is wiped by the sheet-like member 31.

By reeling the sheet-like member 31 by the reeling roller 32, a portion of the sheet-like member 31 at a position facing the ejection opening surface 10 is reeled. This site of the sheet-like member 31 at the position facing the ejection opening surface 10 corresponds to a wiping area for wiping the ejection opening surface 10. Hereinafter, this portion of the sheet-like member 31 at the position facing the ejection opening surface 10 is referred to as wiping area.

FIGS. 4A to 4D are schematic diagrams for illustrating the wiping operation by the wiping unit 30.

When it is determined that recording data for one scanning is accumulated in a print buffer 121 which will be described below, while the carriage 2 is moved from the home position to the back position, the recording operation for one scanning is executed. According to the present exemplary embodiment, since the wiping unit 30 is arranged on the back position side, after the recording operation in a direction from the home position to the back position by the recording head 9 is performed, the wiping operation by the recording head 9 is executed. After the wiping operation, when it is determined that the recording data for the next one scanning is accumulated in the print buffer 121, while the carriage 2 is moved in a direction from the back position to the home position, the recording operation for the next one scanning is executed.

In the wiping operation according to the present exemplary embodiment, first, as illustrated in FIG. 4A, the recording head 9 is moved from the position facing the platen 4 to the position facing the wiping unit 30. Next, as illustrated in FIG. 4B, the abutting member 33 is elevated from an evacuating position, and the abutting member 33 is fixed at an elevated position where the sheet-like member 31 can contact the ejection opening surface 10. Subsequently, by moving the recording head 9 in a state in which the abutting member 33 is fixed at the elevated position, the ejection opening surface 10 is wiped by the sheet-like member 31. At this time, until the ejection opening surface 10 of the recording head 9 passes through the abutting member 33, the abutting member 33 is fixed at the elevated position. As illustrated in FIG. 4C, after the ejection opening surface 10 passes through the abutting member 33, the abutting member 33 is lowered from the elevated position to the evacuating position.

As illustrated in FIG. 3 and FIGS. 4A to 4D, an optical sensor 64 is arranged on a side surface of the back position side of the recording head 9 (the wiping unit 30 side). As illustrated in FIG. 4D, after the abutting member 33 is lowered from the elevated position to the evacuating position, the recording head 9 is moved to the position facing the platen 4. While the recording head 9 is moved to the position facing the platen 4, a color density of the wiping area of the sheet-like member 31 is optically detected by the optical sensor 64. This wiping area is also a portion of the sheet-like member 31 which is caused to abut against the ejection opening surface 10 by the abutting member 33.

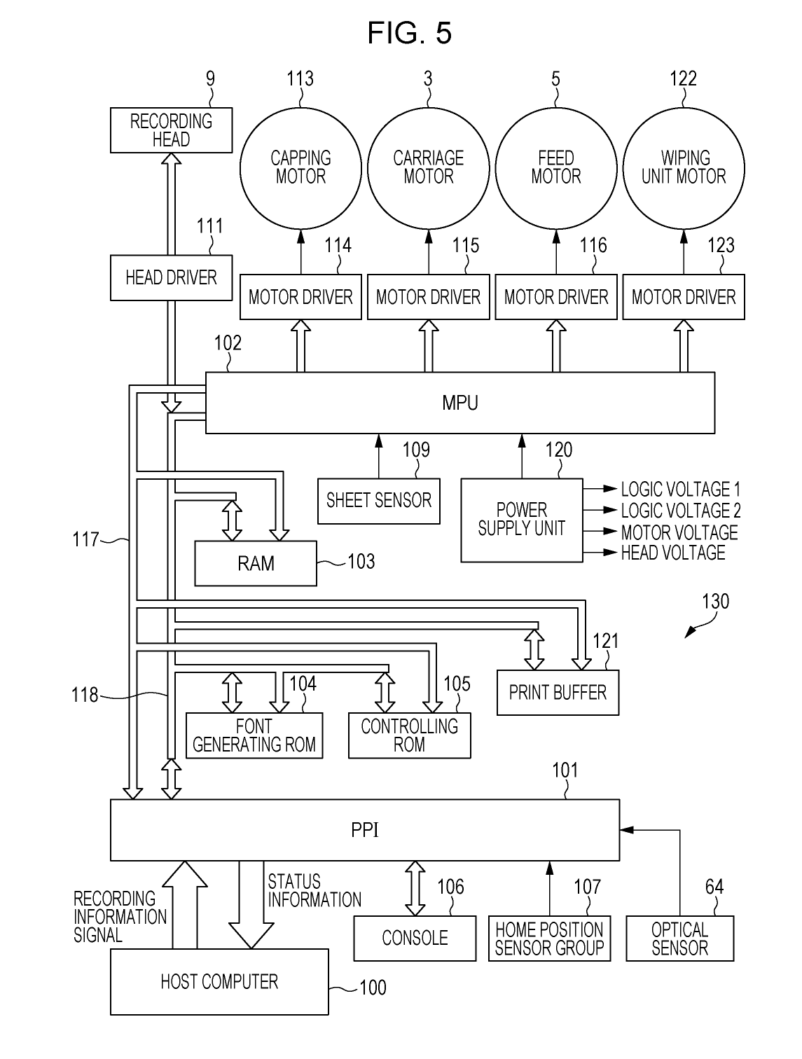

FIG. 5 is a block diagram of a control circuit 130 of the inkjet recording apparatus 1.

A programmable peripheral interface (PPI) 101 receives a recording information signal transmitted from a host computer 100. This recording information signal includes recording data. The recording information signal received by the PPI 101 is transferred to an MPU 102.

The PPI 101 transmits status information of the inkjet recording apparatus 1 to the host computer 100 as appropriate. Furthermore, the PPI 101 performs input and output with a console 106 and receives a signal input from a home position sensor group 107.

The console 106 includes a setting input unit for a user to perform various settings of the inkjet recording apparatus 1 and a display unit that displays a message to the user. The home position sensor group 107 includes a home position sensor that detects that the carriage 2 is at the home position, a capping sensor that detects that the ejection opening surface 10 is capped by the cap 27, and the like.

The MPU 102 controls the inkjet recording apparatus 1 while following a control program stored in a controlling ROM 105. A RAM 103 is used as a work area of the MPU 102 and stores received signals to temporarily store various data. A font generating ROM 104 stores pattern information such as a character or a record corresponding to code information and outputs various pattern information corresponding to input code information. The print buffer 121 stores a storage capacity for a predetermined number of rows of the recording data and temporarily stores the recording data expanded to the RAM 103 or the like.

The ejection number of the ink ejected from the recording head 9 is measured by the MPU 102 or the like from the stored data in the print buffer 121 or the like.

The controlling ROM 105 can also store fixed data corresponding to data used in the control. Herein, the data used in the control is data for determining on whether the wiping operation is performed or the like.

The RAM 103, the font generating ROM 104, the controlling ROM 105, and the print buffer 121 are controlled by the MPU 102 via an address bus 117 and a data bus 118.

A capping motor 113 is a drive source for the elevating and lowering operation of the cap 27, the movement operation of the wiper 26, or the like. A carriage motor 3 moves the carriage 2. The feed motor 5 drives the feed roller which is not illustrated in the drawing and conveys the recording medium P along the conveyance direction Y by the drive of this feed roller. A wiping unit motor 122 rotates the reeling roller 32 and collects the sheet-like member 31 into the reeling roller 32. Motor drives 114, 115, 116, and 123 respectively drive the capping motor 113, the carriage motor 3, the feed motor 5, and the wiping unit motor 122 in accordance with a control of the MPU 102.

A sheet sensor 109 detects a leading end and a trailing end of the recording medium P. A head driver 111 drives a recording element of the recording head 9 in accordance with the recording information signal transmitted from the host computer 100. A power supply unit 120 supplies power to each unit of the control circuit 130. The power supply unit 120 includes an AC adopter and a battery as a drive power supply apparatus.

The optical sensor 64 optically detects the wiping area of the sheet-like member 31. The optical sensor 64 obtains a color density of ink deposited on the wiping area from a detection result of this optical detection. The obtained information of the color density of the wiping area is transmitted from the optical sensor 64 to the PPI 101.

An operation of a configuration of the inkjet recording apparatus 1 according to the present exemplary embodiment will be described.

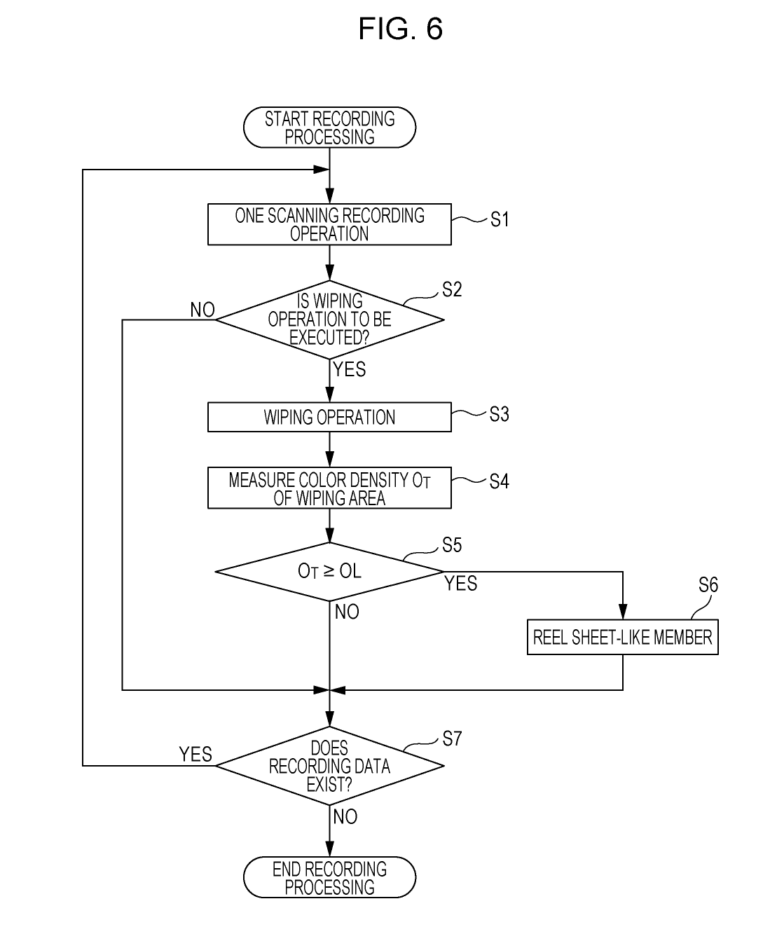

FIG. 6 is a flow chart of the wiping operation according to the present exemplary embodiment. A program for executing a flow chart of a recording processing operation according to the present exemplary embodiment is stored in the controlling ROM 105 of FIG. 5. The program stored in the controlling ROM 105 is read out by the MPU 102 and executed.

When the recording operation is started and recording data for one scanning is accumulated in the print buffer 121, the recording operation for the one scanning is performed in step S1. According to the present exemplary embodiment, first, the recording operation in a direction moving from the home position to the back position is performed by the recording head 9.

After the recording operation in step S1, it is determined whether or not the wiping operation is executed in step S2. According to the present exemplary embodiment, since the wiping unit 30 is located on the back position side, after the recording operation by the recording head 9 from the home position to the back position, it is possible to execute the wiping operation by the recording head 9. Therefore, in a case where Yes is determined in step S2 for the first time, the flow progresses to step S3.

In step S3, after the wiping operation as illustrated in FIGS. 4A to 4C is executed, the flow progresses to step S4. In step S4, as illustrated in FIG. 4D, a color density O_{T} of the wiping area of the sheet-like member 31 is measured by the optical sensor 64. Next, in step S5, it is determined whether or not the color density O_{T} is higher than or equal to a wiping operation threshold OL of the color density.

Herein, the wiping operation threshold refers to an upper value at which it is determined that the wiping area of the sheet-like member 31 has a wiping capability. The wiping capability indicates a performance with which an ejection fault of the ejection opening of the ejection opening surface 10 can be eliminated by the wiping operation. To elaborate, in a case where the color density O_{T} of the wiping area of the sheet-like member 31 is higher than or equal to the wiping operation threshold OL, the ejection fault of the ejection opening surface 10 is not eliminated by the wiping in the wiping area.

In step S5, a relationship of O_{T}≧OL is not established, that is, O_{T}<OL, the flow progresses to step S7 to check whether or not the recording data exists. When the relationship of O_{T}≧OL is established, that is, O_{T} is higher than or equal to the wiping operation threshold OL, the flow progresses to step S6 to execute the reeling operation of the sheet-like member 31, and the flow progresses to step S7 to check whether or not the recording data exists.

In a case where the relationship of O_{T}≧OL is not established, that is, O_{T}<OL, it is determined that the wiping area of the sheet-like member 31 does not lose the wiping capability. Therefore, it is determined that the ejection fault of the ejection opening of the ejection opening surface 10 can be eliminated by the same wiping area again, the reeling operation of the sheet-like member 31 is not executed in step S6. The flow then progresses to step S7, and the recording operation is continued.

In the case of O_{T}≧OL, it is determined that the wiping area of the sheet-like member 31 has already lost the wiping capability. Therefore, it is determined that the ejection fault of the ejection opening of the ejection opening surface 10 is not eliminated by the same wiping area again. For this reason, while the reeling operation of the sheet-like member 31 is executed in step S6, the wiping area that has lost the wiping capability of the sheet-like member 31 is collected. Subsequently, an unused portion of the sheet-like member 31 is unreeled as the wiping area to the position facing the ejection opening surface 10 of the recording head 9. The ejection fault of the ejection opening of the ejection opening surface 10 is eliminated by wiring the ejection opening surface 10 in the wiping area corresponding to this unused portion of the sheet-like member 31.

According to the present exemplary embodiment, it is determined whether or not the sheet-like member 31 is reeled by the reeling roller 32 in accordance with the determination result in step S5.

### Second Exemplary Embodiment

According to the present exemplary embodiment, the wiping area of the sheet-like member 31 is divided for each area for wiping the respective ejection opening columns, and the reeling operation of the sheet-like member 31 is executed in accordance with a color density of each divided area. A description will be given while the components similar to those according to the first exemplary embodiment are omitted.

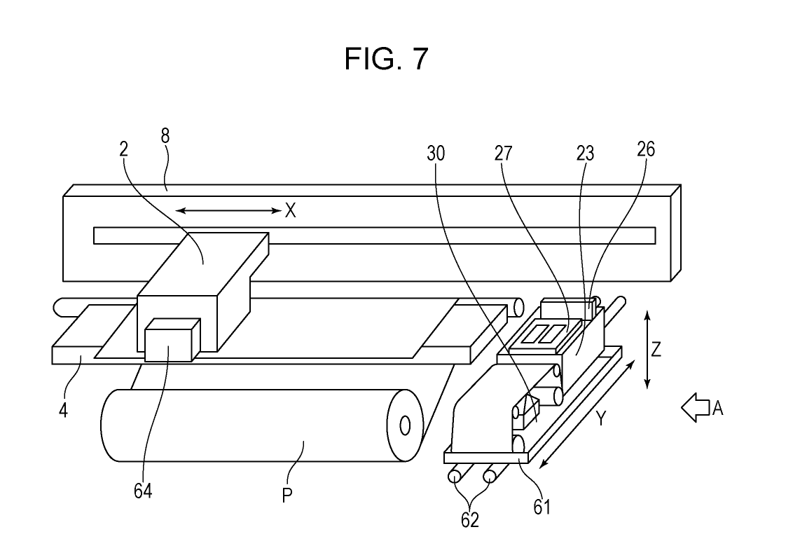

FIG. 7 is a schematic diagram of an internal mechanism of the inkjet recording apparatus 1 according to the second exemplary embodiment. As illustrated in FIG. 7, the recovery unit 23 and the wiping unit 30 are arranged on the home position side and fixed on a moving platform 61. The moving platform 61 is moved in the conveyance direction Y along a slide guide 62. The wiping unit 30 performs the wiping operation in a direction along the ejection opening columns 11 to 16 (the array direction of the ejection openings).

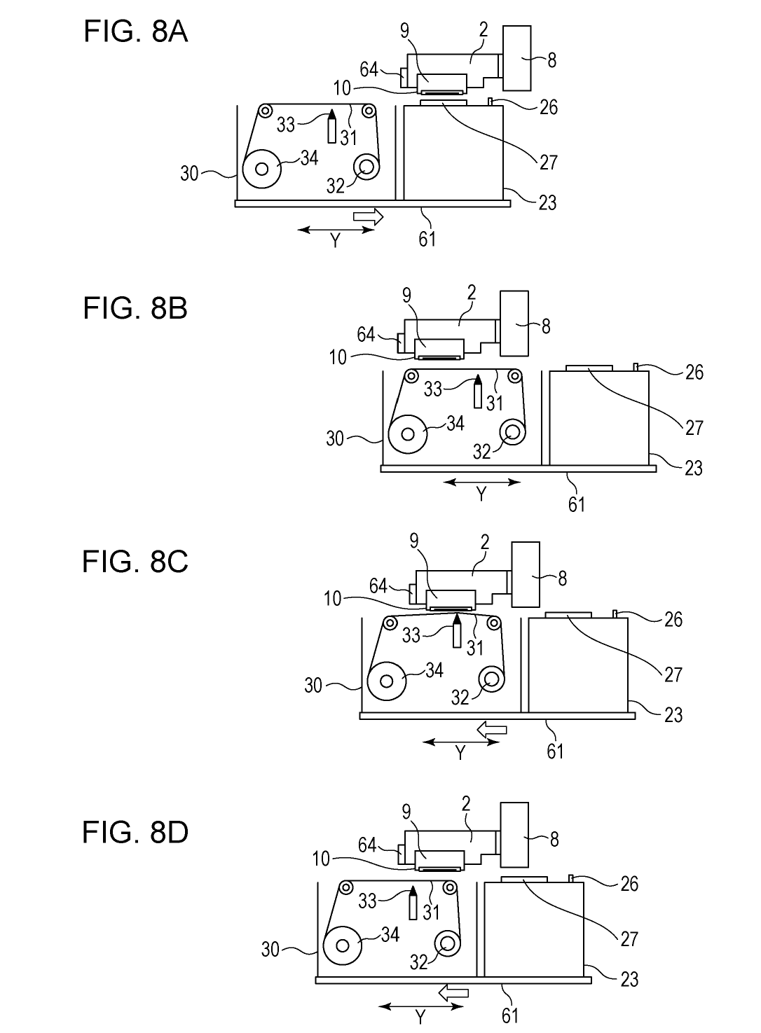

FIGS. 8A to 8C are schematic diagrams of the wiping operation by the wiping unit 30 as seen from an arrow A direction of FIG. 7. As illustrated in FIG. 8A, since the cap 27 is located at a distance from the ejection opening surface 10, the carriage 2 is in a state in which the carriage 2 can be moved in the main scanning direction X.

When it is determined that the recording data for the one scanning is accumulated in the print buffer 121, while the carriage 2 is moved from the home position to the back position, the recording operation for the one scanning is executed. After the start of the recording operation, while the moving platform 61 is moved in the conveyance direction Y, the recovery unit 23 is located on the extension line in the main scanning direction X of the platen 4. This is because auxiliary ejection of the ink is performed towards the recovery unit 23 from the recording head 9 mounted to the carriage 2.

When it is determined that the recording data for the next one scanning is accumulated in the print buffer 121, while the carriage 2 is moved from the back position to the home position, the recording operation for the one scanning is executed. After the execution of the recording operation for the two scannings by this reciprocating operation, the wiping operation by the wiping unit 30 is executed.

In the wiping operation, first, as illustrated in FIG. 8A, the carriage 2 is moved to the position facing the recovery unit 23 and then stops. Next, as illustrated in FIG. 8B, the moving platform 61 is moved to an upstream side of the conveyance direction Y, and the wiping unit 30 stops at the position facing the carriage 2. In a state in which the wiping unit 30 stops at the position facing the carriage 2, the abutting member 33 is elevated from the evacuating position to the elevated position to be fixed. The elevated position refers to a position where the sheet-like member 31 can contact the ejection opening surface 10. Next, as illustrated in FIG. 8C, while the moving platform 61 is moved to a downstream side of the conveyance direction Y in a state in which the abutting member 33 is fixed at the elevated position, the ejection opening surface 10 is wiped by the sheet-like member 31 in the direction along the ejection opening columns 11 to 16 (array direction of the ejection openings). At this time, the abutting member 33 is fixed at the elevated position until the abutting member 33 passes through the ejection opening surface 10 of the recording head 9. After the abutting member 33 passes through the ejection opening surface 10, the abutting member 33 is lowered from the elevated position to the evacuating position.

The used area of the sheet-like member 31 is collected by rotating the reeling roller 32. By executing a changing operation for reeling the used area, an unused area of the sheet-like member 31 faces the ejection opening surface 10 again.

As illustrated in FIG. 7 and FIGS. 8A to 8D, the optical sensor 64 is provided on a side surface of the downstream side of the conveyance direction Y of the recording head 9. In FIG. 8D, successively from FIG. 8C, the moving platform 61 is moved to the downstream side of the conveyance direction Y, and the wiping unit 30 is also moved as a result. As illustrated in FIG. 8D, before the abutting member 33 passes below the optical sensor 64 after the wiping operation of the ejection opening surface 10, the abutting member 33 is lowered from the elevated position to the evacuating position. In this manner, after the abutting member 33 is lowered to the evacuating position, while the wiping unit 30 is moved to the downstream side of the conveyance direction Y, the color density of the wiping area of the sheet-like member 31 is detected by the optical sensor 64.

Ink mist is deposited in the vicinity of the ejection openings that elect the ink corresponding to a generation source of the ink mist. For this reason, the ink mist of the ink ejected by each of the ejection opening columns 11 to 16 itself is also deposited in the ejection opening surface 10 in the vicinity of each of the ejection opening columns 11 to 16.

According to the configuration of FIG. 7, the wiping operation is executed along the direction of the ejection opening columns 11 to 16 provided on the ejection opening surface 10. For this reason, the ink mists deposited in the vicinity of the ejection opening columns 11 to 16 are respectively deposited on the areas for wiring the respective ejection opening columns 11 to 16 in the wiping area. The areas for wiping the ejection opening columns 11 to 16 are divided in a direction intersecting the wiping direction in the wiping area of the sheet-like member 31. Therefore, the ink mists of the ink ejected by the ejection opening columns 11 to 16 are mainly deposited on the areas obtained by dividing the wiping area in the direction intersecting the wiping direction.

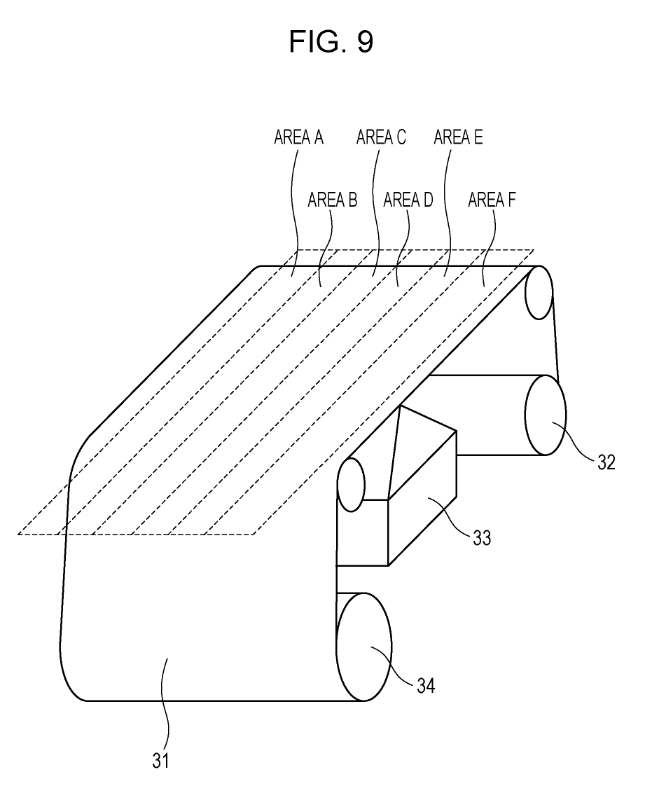

FIG. 9 illustrates six areas A to F obtained by dividing the wiping area of the sheet-like member 31 while corresponding to the ejection opening columns 11 to 16. As described above, the ink mist is deposited on the ejection opening surface in the vicinity of the ejection openings that eject the ink corresponding to the generation source of the ink mist. For this reason, the ink mists of the ink ejected from the respective ejection opening columns 11 to 16 are also deposited in the vicinity of the respective ejection opening columns 11 to 16. Therefore, the ink mists of the ink ejected from the respective ejection opening columns 11 to 16 are mainly deposited on the respective areas A to F. When the ink mist of the ejection opening surface 10 is deposited on the wiping area, the color density of the wiping area is increased. According to the present exemplary embodiment, this color density is obtained by the optical sensor 64 for each of the areas A to F.

An operation of a configuration of the inkjet recording apparatus 1 according to the present exemplary embodiment will be described.

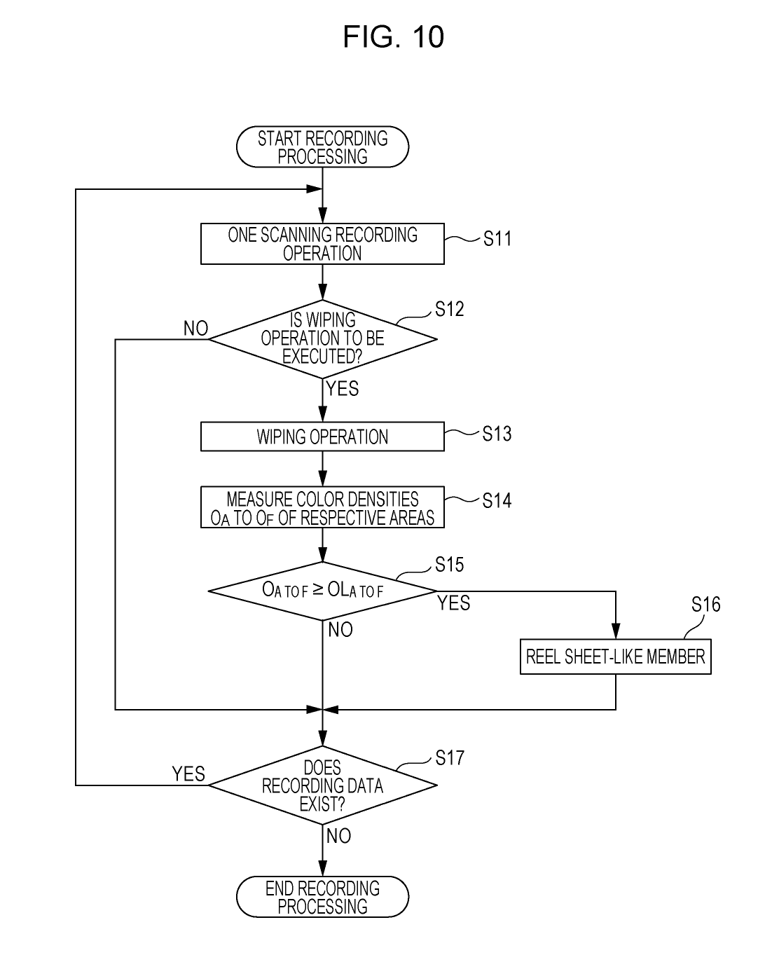

FIG. 10 is a flow chart for the wiping operation according to the present exemplary embodiment. A program for executing the flow chart of the recording processing operation according to the present exemplary embodiment is stored in the controlling ROM 105 of FIG. 5. The program stored in the controlling ROM 105 is read out by the MPU 102 and executed.

Step S11 is similar to the recording operation in step S1 of FIG. 6.

After the recording operation in step S11, it is determined whether or not the wiping operation is executed in step S12. According to the present exemplary embodiment, the wiping unit 30 is not provided on the back position side. For this reason, after the recording operation in the moving direction from the home position to the back position by the recording head 9, the wiping operation by the recording head 9 is not executed. Therefore, No is determined in step S12 for the first time, and the flow progresses to step S17.

In step S17, it is checked whether or not the recording data exist. In a case where the recording data does not exist, No is determined in step S17, and the recording operation is ended. In a case where the recording data exists, Yes is determined in step S17. The flow returns to step S11, and the recording operation is executed again.

The carriage 2 is positioned at the back position by the recording operation in step S11 for the first time. For this reason, in the recording operation in step S11 for the second time, the recording operation is performed in the moving direction from the back position to the home position by the recording head 9. After that, it is determined whether or not the wiping operation is executed in step S12 again. After the second recording operation in step S11, the carriage 2 is located at the home position. For this reason, it is possible to execute the wiping operation by the recording head 9.

When it is determined in step S12 that the wiping operation is executed, the flow progresses to step S13, and the wiping operation described in FIGS. 8A to 8C is executed.

In step S14, as illustrated in FIG. 8D, the color density of the wiping area of the sheet-like member 31 is measured by the optical sensor 64, and the flow progresses to step S15. The optical sensor 64 measures color densities O_{A} to O_{F} for each of the areas A to F illustrated in FIG. 9.

In step S15, it is determined whether or not a color density among the color densities O_{A} to O_{F} is higher than or equal to the wiping operation threshold. Herein, the wiping operation threshold refers to an upper limit value at which it is determined that the wiping area of the sheet-like member 31 has the wiping capability. Herein, the wiping capability indicates a performance with which an ejection fault of the ejection opening of the ejection opening surface 10 can be eliminated by the wiping operation.

Wiping operation thresholds of the color densities O_{A} to O_{F} are respectively set as OL_{A} to OL_{F}. In the wiping area, a color density at which the wiping capability is lost may be varied depending on a type of the ink deposited on each of the areas A to F in some cases. For this reason, values of OL_{A} to OL_{F} may be different from each other.

In step S15, when a relationship of O_{A to F}≧OL_{A to F} is not established, that is, O_{A to F}<OL_{A to F}, the flow proceeds to step S17, and it is checked whether or not the recording data exist. Herein, the relationship of O_{A to F}≧OL_{A to F} indicates that at least one of O_{A} to O_{F} is higher than or equal to the corresponding one of the wiping operation thresholds OL_{A} to OL_{F}.

In a case where the relationship of O_{A to F}≧OL_{A to F} is not established, that is, all of O_{A} to O_{F} are lower than the respective wiping operation thresholds OL_{A} to OL_{F}, it is determined that the wiping area of the sheet-like member 31 does not lose the wiping capability. Therefore, since it is determined that the ejection fault of the ejection opening of the ejection opening surface 10 can be eliminated again in the same wiping area, the reeling operation of the sheet-like member 31 in step S16 is not executed. The flow then proceeds to step S17, and the recording operation is continued.

In a case where the relationship of O_{A to F}≧OL_{A to F} is established, that is, a case where at least one of O_{A} to O_{F} is higher than or equal to the corresponding one of the wiping operation thresholds OL_{A} to OL_{F}, the flow proceeds to step S16, and the reeling operation of the sheet-like member 31 is executed. After the reeling operation in step S16 is executed, the flow proceeds to step S17, and it is checked whether or not the recording data exist.

In a case where the relationship of O_{A to F}≧OL_{A to F} is established, it is determined that the wiping area of the sheet-like member 31 has already lost the wiping capability. Therefore, it is determined that the ejection fault of the ejection opening of the ejection opening surface 10 is not eliminated by the same wiping area again. For this reason, by executing the reeling operation of the sheet-like member 31 in step S16, the wiping area where the wiping capability of the sheet-like member 31 has lost is collected. Subsequently, an unused site of the sheet-like member 31 is unreeled to the position facing the ejection opening surface 10 of the recording head 9 as the wiping area. The ejection opening surface 10 is wiped by this unused site of the sheet-like member 31.

According to the present exemplary embodiment, the reeling operation is executed in accordance with contamination of the wiping area parts corresponding to the respective ejection opening columns instead of contamination on the entire wiping area. For this reason, it is possible to execute the reeling operation of the sheet-like member 31 at an appropriate timing in accordance with the partial contamination of the wiping area.

### Other Exemplary Embodiments

Exemplary embodiments of the present invention can widely be applied to various inkjet recording apparatus that record an image by using a recording head that can eject ink from an ejection opening. Therefore, the inkjet recording apparatus is not limited to the apparatus including a serial head and may also be an apparatus including a line head.

In addition, the wiping member according to the exemplary embodiments of the present invention is not limited to the sheet-like member and may also be a belt-like member.

Moreover, the configuration of changing the site corresponding to the wiping area of the wiping member according to the exemplary embodiments of the present invention is not limited to the configuration of reeling the sheet-like member. For example, a configuration of cutting and collecting the contaminated site instead of reeling the contaminated site of the sheet-like member may also be adopted.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-125713 filed Jun. 14, 2013, which is hereby incorporated by reference wherein in its entirety.

1. An inkjet recording apparatus comprising:
an inkjet recording head including an ejection opening surface from which ink is ejected;
a wiping unit configured to wipe the ejection opening surface;
a changing unit configured to perform a changing operation for changing a wiping area of the wiping unit;
a determination unit configured to determine a contamination state of the wiping area; and
a control unit configured to cause the changing unit to perform the changing operation on the basis of a determination result of the determination unit.

2. The inkjet recording apparatus according to claim 1,
wherein the determination unit includes a detection unit configured to optically detect the wiping area.

3. The inkjet recording apparatus according to claim 2,
wherein the detection unit detects a color density of the wiping area.

4. The inkjet recording apparatus according to claim 3,
wherein the control unit causes the changing unit to perform the changing operation in a case where the color density is higher than or equal to a threshold.

5. The inkjet recording apparatus according to claim 3,
wherein the detection unit detects the color density for each of areas divided in a direction intersecting a wiping direction of the wiping unit.

6. The inkjet recording apparatus according to claim 5,
wherein the control unit causes the changing unit to perform the changing operation in a case where the color density for each divided area is higher than or equal to a threshold.

7. The inkjet recording apparatus according to claim 6,
wherein the threshold is set for each divided area.

8. The inkjet recording apparatus according to claim 1,
wherein a plurality of ejection opening columns where a plurality of ejection openings are arranged on the ejection opening surface along a predetermined direction.

9. The inkjet recording apparatus according to claim 8,
wherein the plurality of ejection opening columns eject two or more types of ink.

10. The inkjet recording apparatus according to claim 1,
wherein a plurality of ejection opening columns where a plurality of ejection openings are arranged on the ejection opening surface along a predetermined direction, and
wherein the wiping direction is a direction intersecting the predetermined direction.

11. The inkjet recording apparatus according to claim 10,
wherein the plurality of ejection opening columns eject two or more types of ink.

12. The inkjet recording apparatus according to claim 1,
wherein the wiping unit is a sheet-like member, and
wherein the changing unit moves an unused wiping area to a position facing the ejection opening surface.

13. A control method for a wiping unit in an inkjet recording apparatus that includes an inkjet recording head including an ejection opening surface from which ink is ejected and the wiping unit configured to wipe the ejection opening surface, the control method comprising:
wiping the ejection opening surface by the wiping unit;
determining on a contamination state of a wiping area of the wiping unit; and
changing the wiping area of the wiping unit on the basis of a determination result in the determining.
